(19) United States
(12) Patent Application Publication
(10) Pub. No.: US 2026/0368528 A1
(43) Pub. Date: Nov. 19, 2026

(54) SUPERNET TRAINING WITH LOW RANK ADAPTERS

(71) Applicant: Arm Limited, Cambridge (GB)

(72) Inventors: Shuokai Pan, Alconbury Weald (GB); Dibakar Gope, Austin, TX (US)

(21) Appl. No.: 19/210,237

(22) Filed: May 16, 2025

(51) Int. Cl. G06N 3/086

(52) U.S. Cl. CPC G06N 3/086

(57) ABSTRACT

A neural network subnet topology may be generated from a neural network supernet by generating a neural network supernet embedding one or more of a plurality of neural network subnets having different topologies. A neural network subnet may be extracted from the neural network supernet by extracting a fraction of nodes from the neural network supernet, and a low rank adapter associated with the extracted neural network subnet may be trained. The low rank adapter may receive at least a portion of the same inputs as the extracted candidate neural network, and has at least a portion of the low rank adapter's outputs may be combined with outputs of the extracted candidate neural network. The extracted neural network subnet and the associated trained low rank adapter may be provided as an output neural network.

### FIELD

The field relates generally to neural network topology training and selection, and more specifically to training at least a portion of a supernet with a low rank adapter.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

Modern computerized devices such as smartphones perform many of the functions that were primarily performed by large desktop computers a generation ago, such as web browsing, text messaging, emailing, videoconferencing, and playing video games. Such devices increasingly employ advanced technologies such as artificial intelligence, three-dimensional rendered graphics, and the like. Apple Siri, Google Assistant, and ChatGPT are examples of voice assistants that employ artificial intelligence such as neural networks, pretrained generative transformers, and the like to enable natural language communication and provide answers to natural language questions. Three-dimensional graphics rendering pipelines also increasingly employ artificial intelligence such as neural networks to predict motion and lighting of objects, de-noise or otherwise filter rendered images, and to perform other such tasks. Augmented or virtual reality may also employ significant neural network processing to recognize objects, provide realistic rendering, and the like.

But, these artificial intelligence tools such as neural networks are often deployed on battery-powered devices with limited power and compute capacity, such as smart phones, tablet computers, or wearable electronics. Performance constraints, such as rendering image frames in real time or responding to inputs such as voice prompts or captured images with a reasonable latency are also important to delivering a quality user experience. Neural networks and other artificial intelligence tools that perform well on a large computer may therefore need to be scaled down to perform well under the processing capacity, electrical power, and working memory constraints of devices such as smart phones.

Determining how to scale down a neural network for use on a device with limited resources while preserving the neural network's performance is a complex task. Because the neural network is typically trained using methods such as backpropagation of error and gradient descent, the explicit contribution of each node or portion of the neural network can be hard to quantify or determine. Typical approaches include defining model accuracy constraints and acceptable latency and searching for topologies meeting both constraints using trial and error, but such approaches rely heavily upon chance to find an acceptable solution and are inefficient. A scaled-down neural network may also not perform as well as a neural network of the same size that has been natively trained to perform the same task, resulting in a noticeable or undesirable reduction in network performance.

For reasons such as these, a need exists for improved selection of neural network architectures meeting performance and resource constraints.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 is a system diagram showing selection and deployment of a candidate neural network in a resource-constrained environment, consistent with an example embodiment.

FIG. 2 shows training low rank adapters associated with candidate neural networks, consistent with an example embodiment.

FIG. 3 is a flow diagram of a method of training a supernet by training a plurality of subnets and associated low rank adapters, consistent with an example embodiment.

FIG. 4 comprises pseudocode listings for methods of training a neural network subnet with an associated low rank adapter, consistent with an example embodiment.

FIG. 5 is a chart showing accuracy of various sizes of subnets derived from a standard supernet, a pretrained supernet with a low rank adapter, and a supernet trained simultaneously with a low rank adapter, consistent with an example embodiment.

FIG. 6 is a flow diagram of a method of performing an evolutionary search for a subnet and associated low rank adapter for deployment using genetic modification, consistent with an example embodiment.

FIG. 7 is a schematic diagram of a neural network, consistent with an example embodiment.

FIG. 8 is a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As neural networks are employed to perform increasingly complex tasks such as natural language processing, rendered image sequence processing, and content creation, the size and complexity of such neural networks continues to grow. Designing and selecting neural networks that run on computing devices having limited computational resources, limited power or battery life, or limited memory often involves a compromise between architectural constraints, such as the neural network size and latency, and performance constraints, such as accuracy in predicting a desired result. In one such example, real-time chatbot applications using large language models (or LLMs) may have strict tokens per second requirements for providing an acceptable user experience, but be constrained by the processor, memory, and battery power available on a smartphone hosting the chatbot.

Selection of neural network architectures providing acceptable accuracy while meeting computing environment constraints is not a trivial task, as it is difficult to understand or quantify the role that various nodes or segments of a neural network play in providing accurate predictions or outputs. Random selection or trial-and-error may therefore be employed to generate candidate neural network topologies, such that those random topologies providing the best mix of accuracy and latency or resource constraints is selected. Developers of applications such as these may desire improved methods of selecting a neural network topology when facing such constraints, such as to improve the performance of their software in constrained computing environments or to demonstrate better performance numbers for machine learning tasks on specific hardware such as a current-generation mobile processor.

Some examples described herein therefore address concerns such as these by providing improved methods of selecting a neural network architecture such as when computing resources are constrained. In one such example, an output neural network may be generated from a neural network supernet by generating a neural network supernet embedding one or more of a plurality of neural network subnets having different topologies. A neural network subnet may be extracted from the neural network supernet by extracting a fraction of nodes from the neural network supernet, and a low rank adapter associated with the extracted neural network subnet may be trained, the low rank adapter receiving at least a portion of the same inputs as the extracted neural network subnet and having at least a portion of the low rank adapter's outputs combined with outputs of the extracted candidate neural network. A selected extracted neural network subnet and its associated trained low rank adapter may be provided as an output neural network, such as to meet architectural constraints of an end user device.

In another example, a neural network topology may be selected by selecting a plurality of neural networks subnets having different topologies from a super-neural network, and associating each of the plurality of neural network subnets with a different low rank adapter. The plurality of neural network subnets and their associated low rank adapters may be trained to train the supernet and/or the associated low rank adapters, and the neural network subnets and their associated low rank adapters may be filtered, based, at least in part, on one or more performance metrics from among the selected plurality of candidate neural networks and their associated low rank adapters. One or more genetic modifications may be applied to the filtered neural network subnets and their associated low rank adapters, and a genetic-modified neural network subnet and associated low rank adapter may be selected based, at least in part, on one or more performance metrics as the selected neural network topology.

Neural network supernets derived from a neural network supernet and augmented with an associated low rank adapter may be trained to provide better performance than the neural network subnet alone, providing an improvement in performance and size of the neural network subnet. Further, neural network topology selection methods such as those described herein can improve the performance of neural networks having topology constraints, such as by identifying candidate neural networks meeting topology or latency constraints that have improved prediction accuracy or other performance metrics.

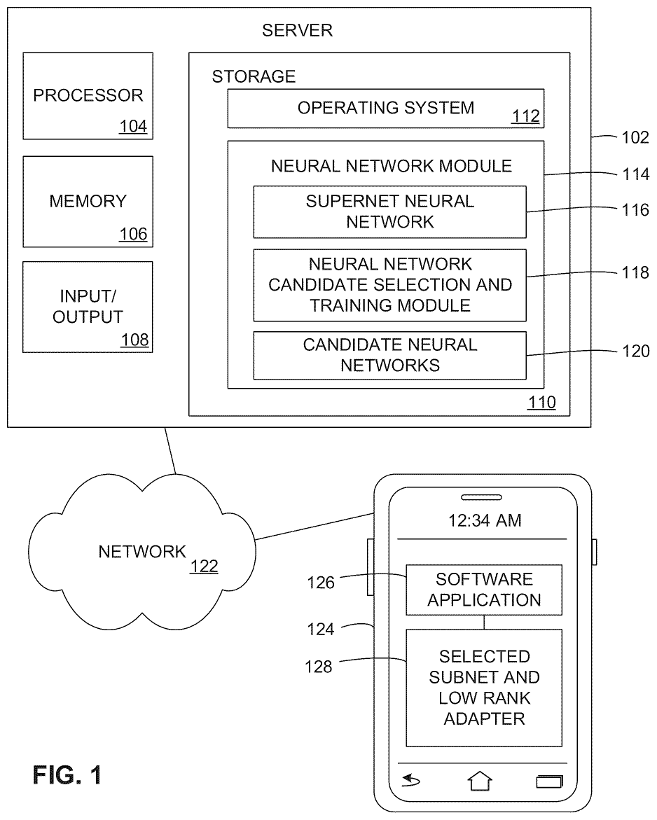

FIG. 1 is a system diagram showing selection and deployment of a candidate neural network in a resource-constrained environment, consistent with an example embodiment. Here, a server 102 includes a processor 104 operable to execute computer program instructions and a memory 106 operable to store information such as program instructions and other data while computerized server 102 is operating. The server may exchange electronic data, receive input from a user, and perform other such input/output operations with input/output 108. Storage 110 may store program instructions including an operating system 112 that provides an interface between software or programs available for execution and the hardware of the server, and that may manage other functions such as access to input/output devices. The storage 110 may also store program instructions and other data for a neural network module 114, including supernet neural network 116, a neural network candidate selection and training module 118, and candidate neural networks 120. The candidate neural networks may be associated with low rank adapters, such that the low rank adapters may be trained to improve the performance of the candidate neural networks and delivered with the candidate neural networks to provide improved performance. In the example shown here, the computerized device may also be coupled via a network 122 such as the Internet to one or more user devices 124, such as smartphones, tablet computers, or other such computerized devices.

The user device 124 in this example comprises a software application 126 that is operable to execute computer program instructions, incorporating the selected neural network subnet and associated low rank adapter 128 that neural network candidate selection module selects from among candidate neural networks 120. In a more detailed example, user device 124 also comprises a memory that is operable to store information such as computer instructions and data being processed by executing programs, input/output such as a network connection to public network 122, and storage operable to store program instructions and data such as an operating system and a software application 126.

In operation, a supernet neural network 116 may be trained to perform a specific function, such as to predict language using a large language model (LLM), to process or filter rendered image streams, or to perform other such complex functions. The supernet neural network 116 may have a larger topology than is practical to run on a device having constrained resources such as a smartphone or tablet computer, such as by containing a greater number of nodes or other topological features or having a greater latency in generating a prediction than is acceptable on a mobile device. In further examples, the neural network module 114 may be operable to train the supernet neural network using methods such as backpropagation and gradient descent or other training methods.

One or more candidate neural network subnets meeting latency, resource, or other such constraints may be selected via neural network candidate selection and training module 118, and may be stored as candidate neural networks at 120. In further examples, these candidate neural network subnets may be derived from the super neural network 116 using methods such as random selection, truncation, genetic or evolutionary modification, or other such methods. Genetic modification in some examples may include creation of candidate neural networks by cross-over of existing candidate neural networks to generate new candidate neural networks, by mutation of existing candidate neural networks to generate new candidate neural networks, or by a combination of such methods or iterated or repeated use of such methods.

Candidate neural network subnets may be evaluated for their compliance with hardware constraints and latency as well as for performance such as accuracy in predicting a certain result via neural network candidate selection and training module 118. One or more selected candidate neural network subnets meeting hardware or latency constraints may be further trained via the neural network candidate selection and training module using an associated low rank adapter, such as training either just the associated low rank adapter or training the selected neural network subnet and low rank adapter weights together. The neural network subnet and trained associated low rank adapter may be evaluated together for compliance with hardware constraints and for accuracy, such that the neural network subnet and associated low rank adapter having the best accuracy at predicting a desired result or other such metrics may be deployed via a network 122 such as the Internet, a cellular network, an app store, or the like to one or more remote devices such as smart phone 124.

The smart phone 124 in this example may receive the selected candidate neural network subnet and associated trained low rank adapter, such as embedded within a software application 126, and may install and execute the software application 126 and associated selected neural network subnet and associated low rank adapter 128 to perform desired functions such as processing rendered image streams or interacting with a user via a large language model (LLM). The selected neural network in a more detailed example may be selected from the candidate neural network subnets 120 and modified using a low rank adapter that is trained before deployment.

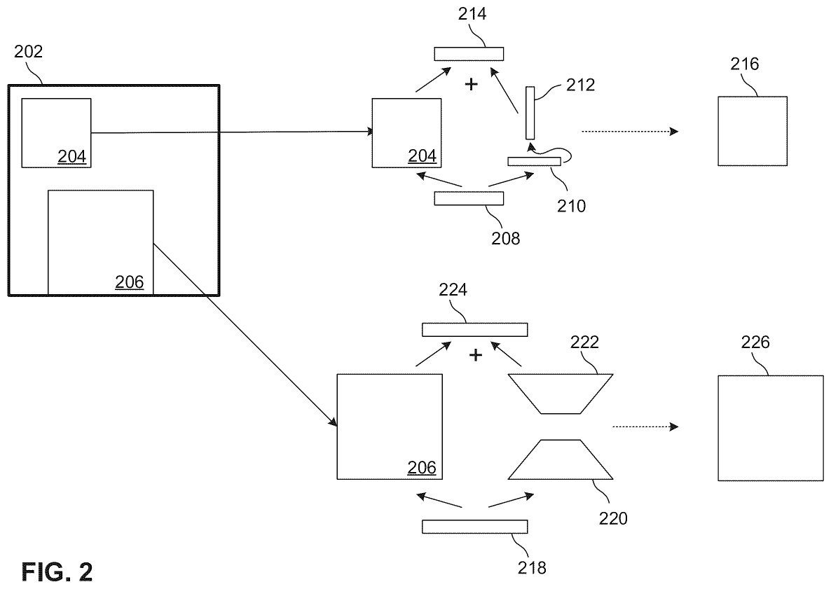

FIG. 2 shows training low rank adapters associated with candidate neural networks, consistent with an example embodiment. Here, a super neural network or supernet is shown at 202, and different candidate neural networks derived from the super neural network are shown at 204 and 206. In a more detailed example, the super neural network embeds each of the candidate neural networks within it, and may correspond to a search space for candidate neural network subnets. Training the supernet 202 may include training the super neural network using a variety of training samples, and in further examples may also use neural networks subnets embedded within the super neural network for at least some training samples where only the neural network subnet weights are updated during such training iterations. In a more detailed examples, a limited number of neural network subnets are used for training, such as selecting several random neural network subnets for each training iteration and updating only the weights associated with the selected neural network subnets in each iteration. Candidate neural network subnets may be derived from the trained supernet 202 as shown at 204 and 206, by simply selecting a subset of nodes and weights of the super neural network with no further training required, but the performance of such a subnet may in some examples be measurably worse than if the subnet were trained in isolation.

The example of FIG. 2 therefore introduces a low rank adapter associated with each neural network subnet extracted from the supernet 202, such that the low rank adapter can be trained once the neural network subnet has been extracted can be either integrated into the neural network subnet or used alongside the candidate neural network during later deployment and inference. In a more detailed example, a super neural network or supernet such as is shown at 202 is pretrained, and one or more neural network subnets or candidate neural networks 204 and 206 are extracted from the supernet. The subnets comprise at least a portion of the interconnected nodes, weights, activation functions, and other such features of the supernet, and optionally may share at least some inputs and/or outputs with the supernet. Each neural network subnet such as 204 and 206 is in this example associated with a low rank adapter, as shown at 210 and 212. Each low rank adapter as shown here comprises a neural network structured to reduce the number of trainable weights, and to have a low rank or number of connections in the interior of the network. Various example configurations may resemble rank decomposition matrices, autoencoders, or other such, and may be configured to add a low rank delta or difference to the pretrained weights in the neural network subnets to improve their performance or to tailor them for specific purposes.

In a more detailed example of a low rank adapter, a 500×500 subnet as reflected at 204 may be associated with a 500×2 matrix as shown at 210 and 2×500 matrix as shown at 212, each matrix comprising trainable weights in the associated low rank adapter. Inputs 208 are provided to both the subnet 204 and to the low rank adapter's input matrix 210, and outputs of the subnet and the low rank adapter's output matrix 212 are added (or in alternate examples, multiplied or otherwise combined) to generate the output 214. The total number of weights in the subnet 204 in a more detailed example may be 500×500, or 250,000, while the total number of weights in the low rank adapter may be (2×500)+(500×2), or 2000, such that by training the weights in the low rank adapter rather than the weights in the subnet the number of trainable weights is reduced by 125×. The low rank adapter may further be trained using a relatively small training set, such as hundreds of training input and output pairs rather than hundreds of thousands or millions to obtain acceptable results, greatly reducing the computational burden in fine-tuning the subnet with a low rank adapter with subnet weights frozen instead of training the entire subnet.

In another detailed example, a subnet 206 is shown receiving inputs 218 that are provided to subnet 206 and low rank adapter input network 220. The low rank adapter input network 220 may have very few layers, such as low single digit numbers of layers, reduced to a low number of outputs, such as a low single digit number of outputs, connected to a low rank adapter output network 222. The low rank adapter output network may have an architecture similar but inverted relative to the architecture of low rank adapter input network 220, such that relatively few inputs are connected through relatively few layers to an output layer, which provides an output that may be combined with the output of candidate subnet 206 to generate output 224. Although the examples shown here show low rank adapters comprising square matrices at 210 and 212 and configured to resemble an autoencoder at 220 and 222, other low rank adapters may take other forms, and are within the scope of what may be considered low rank adapters.

The low rank adapter may be trained in some examples by freezing or locking the weights of the candidate subnet such as 204 or 206, and using backpropagation and gradient descent or other such training methods to adjust the weights of the low rank adapter. Because the low rank adapter may typically have far fewer nodes than the candidate subnet, the low rank adapter is computationally less expensive to train than the associated neural network subnet and may be trained with relatively few training samples (e.g. hundreds or thousands instead of millions) to achieve acceptable results. In a further example, multiple low rank adapters may be trained for a particular candidate subnet, such as to perform different purposes using the same subnet paired with different low rank adapters. In one such example, a candidate subnet may use one associated low rank adapter to create summaries of text documents, but a different low rank adapter to generate creative content from a prompt.

Addition of a low rank adapter such as those shown in the example of FIG. 2 to a neural network subnet may improve the ability of the subnet to meet certain accuracy or performance goals, or to perform certain tasks. In some such examples, subnets and associated low rank adapters may be used for different layers or for all layers of a neural network, providing improved performance in predicting a desired result to each of the layers where a low rank adapter is employed. In applications in which the subnet is used to perform different tasks, such as a large language model used for different purposes, different low rank adapters may be trained for each such defined task to independently improve the candidate subnet's performance in performing the different tasks. Switching between such tasks may therefore involve only substituting one trained low rank adapter for another, providing a significant increase in accuracy and performance with very little computational overhead.

The low rank adapters in some examples may be incorporated into or combined with the subnets such as during deployment (or inference), such as by combining subnet 204 with low rank adapter matrix weights 210 and 212 to generate a combined subnet 216, or by combining subnet 206 with low rank adapter input network 220 and low rank adapter output network 222 to generate a combined subnet 226. This may be particularly useful in embodiments in which the combined subnet will be used for a single particular purpose and there is no need to change low rank adapters associated with the subnet or subnets.

The neural network subnets such as those shown at 204 and 206 of FIG. 2 may be evaluated for compliance with architectural constraints of an intended platform, such as number of nodes and computational speed, and for performance, such as accuracy in predicting a desired output. It may be desirable to select the most accurate candidate subnet from among several candidate subnets meeting architectural constraints so that the candidate subnet that is deployed has a higher accuracy than if no such subnet candidate search was conducted. Subnets may be selected from different regions of the supernet 202, and may be modified using methods such as genetic modification in an evolutionary search between rounds of candidate subnet selection to further improve the performance of the selected candidate subnet.

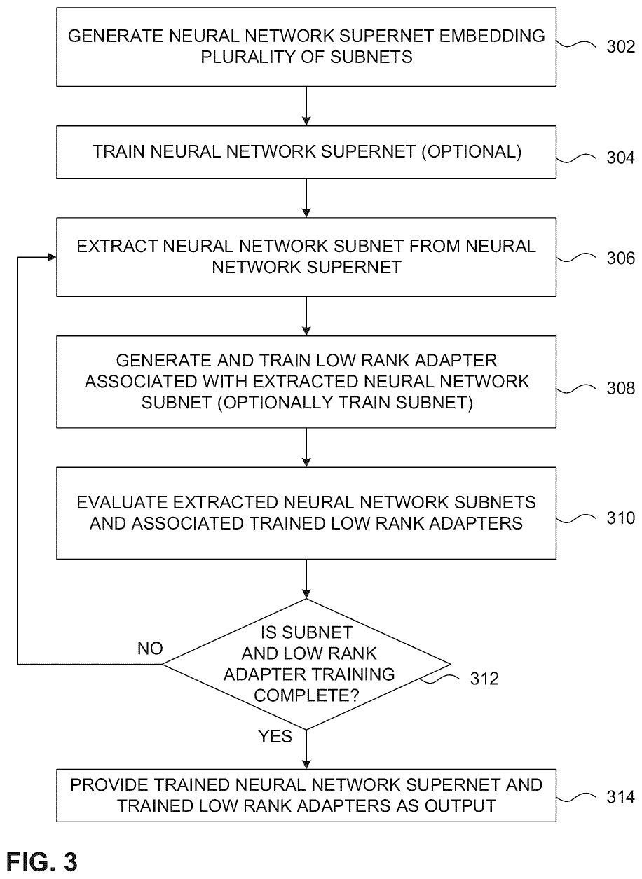

FIG. 3 is a flow diagram of a method of training a supernet by training a plurality of subnets and associated low rank adapters, consistent with an example embodiment. At 302, a neural network supernet is generated, such as a large language model transformer or other type of neural network. The supernet may be large enough that it is difficult to run on some devices, such as due to memory or nonvolatile storage limits, compute capacity limits, or other such architectural constraints. The neural network supernet may be pre-trained at 304, such as by using a set of training data to train the neural network supernet to provide a desired predicted output with a given input using backpropagation, gradient descent, and/or other such training methods. In other examples, the neural network supernet may be initialized such as with random numbers, and may be trained along with low rank adapter training as will be shown at 308.

One or more neural network subnets may be extracted from the neural network supernet at 306, such as by extracting a portion of weights, connections, activation functions, and other elements of a portion of the neural network supernet. The neural network subnets may be substantially smaller than the neural network supernet, such as to enable the neural network subnets to run on a computerized system having architectural constraints or limited computing resources such as a smart phone, a tablet computer, a set-top box, or the like.

At 308, a low rank adapter is generated for each of the neural network subnets extracted at 306, such as are shown in the example of FIG. 2. The low rank adapter in various embodiments may comprise one or more matrixes, funnels, or other configurations of neural network nodes and/or weights that are trainable using methods such as backpropagation, gradient descent, and the like. The low rank adapter may then be trained while the weights of the extracted neural network subnet are frozen or remain static, such that only a relatively small number of weights need to be trained and a relatively small amount of training data employed in training the low rank adapter may result in an acceptable output accuracy. In other examples, both the low rank adapter and the extracted neural network subnet may be trained at a significant additional training cost, such as where further training of the subnet may be desired for a particular application or to further improve overall accuracy of the subnet and the associated low rank adapter.

The one or more extracted neural network subnets and their associated trained low rank adapters may be evaluated at 310, such as by providing additional training verification data sets comprising inputs and desired corresponding outputs to the neural network subnets and associated low rank adapters, and measuring a difference between the resulting outputs and the desired outputs. If an extracted neural network subnet and associated trained low rank adapter meet such training goals at 312, training is complete and the one or more extracted subnets and their associated low rank adapters may be provided as an output at 314. If the training goals, such as accuracy at predicting a desired outcome, are not yet met at 312, the process may continue at 306 with another round of training an additional low rank adapter and optionally the associated subnet.

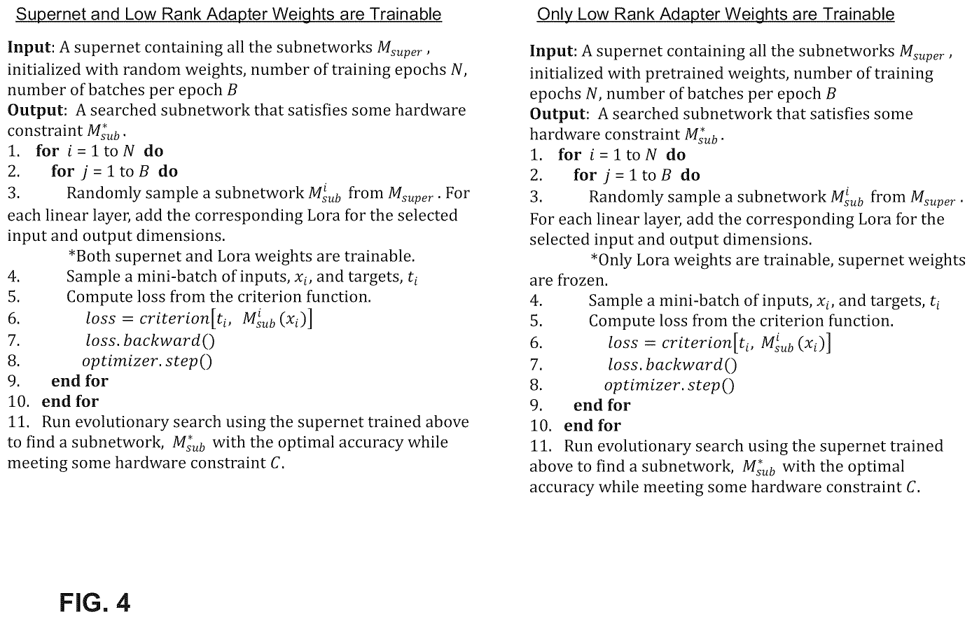

FIG. 4 comprises pseudocode listings for methods of training a neural network subnet with an associated low rank adapter, consistent with an example embodiment. The left side of FIG. 4 shows a pseudocode listing for a method of training a subnet and associated low rank adapter where the subnet and/or the supernet are trainable, and the right side of the figure shows a pseudocode listing for a similar method of training a subnet and associated low rank adapter where the subnet/supernet weights are frozen and are not further trainable.

On the left, the pseudocode listing for trainable low rank adapter weights and trainable supernet/subnet weights start with a supernet embodying all the subnets that may be searched in an evolutionary subnet search. The supernet may be initialized with random weights, and may be trained in a number of training epochs N, with each epoch using a number of batches of training samples B.

The training process starts with nested FOR loops on numbered lines one and two, repeating the below process for the number of batches of training material per epoch and for the number of epochs of batches. A random subnet is extracted at line three, and a low rank adapter is created associated with the subnet. In this example, both the subnet weights and the low rank adapter weights are trainable, and modifications to the subnet weights affect or are carried through to the corresponding weights in the supernet from which the subnet is derived. Pseudocode lines four through eight train the low rank adapter and the subnet weights such as by calculating a loss and using backpropagation, gradient descent, and other such methods to train the neural network weights. This process repeats, training both the supernet and the low rank adapters associated with the selected subnets, such that the supernet becomes trained as a result of training the various subnets with their associated low rank adapters.

Once a sufficient number of batches and epochs of training data are complete and the corresponding FOR loops end at pseudocode lines nine and ten, an evolutionary search can be performed to find a trained subnet and associated low rank adapter that meets a desired or best observed accuracy or performance level meeting the hardware constraints, such as the constraints of an end user device like a smart phone having limited memory capacity and computational resources.

On the right, the pseudocode listing for trainable low rank adapter weights and fixed or frozen supernet/subnet weights starts with a trained supernet embodying all the subnets that may be searched in an evolutionary subnet search. The supernet may be pretrained with its own epochs and batches of training data, or may share at least some training data with the low rank adapter training process.

The training process similarly starts with nested FOR loops on numbered lines one and two, repeating the below process for the number of batches of training material per epoch and for the number of epochs of batches as with the previous pseudocode example. A random subnet meeting the architectural constraints is extracted at line three, and a low rank adapter is created associated with the subnet. In this example, only the low rank adapter weights are trainable, and the subnet weights and corresponding supernet weights are not trainable and are frozen or fixed. Pseudocode lines four through eight train the low rank adapter in view of the frozen or fixed subnet weights such as by calculating a loss and using backpropagation, gradient descent, and other such methods. This process repeats, training the low rank adapters associated with the selected subnets such that the low rank adapters associated with the various subnets may improve the accuracy of the various subnets.

Once a sufficient number of batches and epochs of training data are complete and the corresponding FOR loops end at pseudocode lines nine and ten, an evolutionary search can be performed to find a subnet from among the subnets and their associated trained low rank adapters that meets a desired or best observed performance level meeting the hardware constraints, such as the constraints of an end user device like a smart phone having limited memory capacity and computational resources.

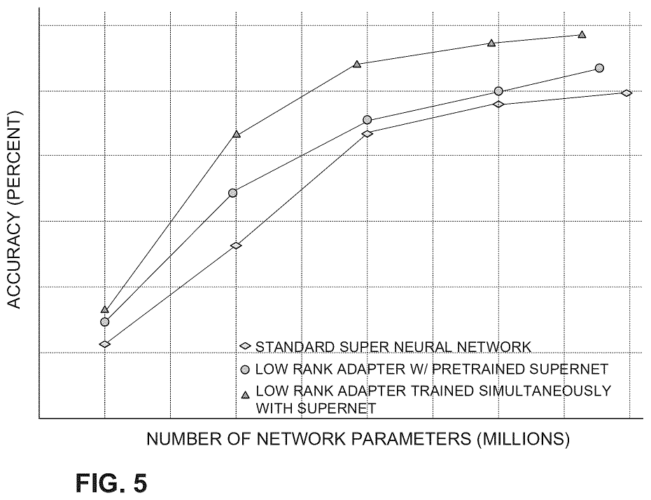

FIG. 5 is a chart showing accuracy of various sizes of subnets derived from a standard supernet, a pretrained supernet with a low rank adapter, and a supernet trained simultaneously with a low rank adapter, consistent with an example embodiment. The chart shown in FIG. 5 reflects an increase in performance on the Y axis with a greater number of network parameters or nodes on the X axis, for each of three different subnet neural network constructs. The bottom curve linking data points represented with diamonds represents the accuracy of subnets extracted from a standard super neural network, with no additional modification or training and without the benefit of an augmenting low rank adapter. The middle curve linking data points represented with circles reflects the accuracy of various sizes of neural network subnets with a pretrained supernet and a low rank adapter trained to augment the extracted subnets with frozen weights. A significant performance improvement over subnets extracted from a trained supernet with no low rank adapters can be seen at each neural network subnet size.

The top curve linking data points represented by triangles reflects the accuracy of various sizes of neural network subnets with a supernet is trained along with associated low rank adapters and may not be pretrained, as reflected in the left-hand pseudocode example of FIG. 4. In this example, the weights of a subnet are trained along with the weights of an associated low rank adapter, such that the subnet weight modifications affect the corresponding weights of the supernet. The supernet is therefore trained to perform well with various low rank adapters, and a significant improvement in performance over a pretrained neural network supernet that is frozen with trainable low rank adapters (denoted by the curve linking data points represented by circles) can be seen at every network size shown.

The chart shown in FIG. 5 represents experimental data with one particular supernet trained for one particular purpose, and other examples may vary. The origin of the chart shown in FIG. 5 is not zeros, but the chart instead represents the useful portion of a curve having usable accuracy percentages and network parameter sizes that are derived from a plausible example of a constrained resource computing environment such as a smart phone or other such device. The example of FIG. 5 illustrates how low rank adapters can improve the performance of subnets at various network sizes, and how allowing the low rank adapter training process to train the supernet to work in conjunction with low rank adapters can further improve the performance of subnets extracted from the supernet and paired with trained low rank adapters.

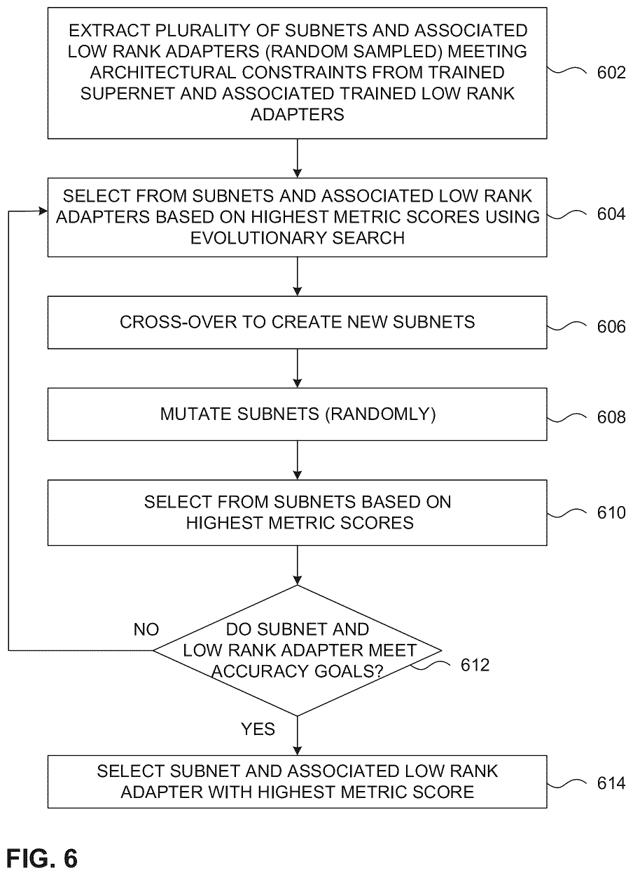

FIG. 6 is a flow diagram of a method of performing an evolutionary search for a subnet and associated low rank adapter for deployment using genetic modification, consistent with an example embodiment. Genetic modifications in this example comprise modifications resembling genetic modifications that occur between generations in living organisms, such as cross-over, random mutation, and the like. By employing genetic modification and filtering the results to simulate a process such as natural selection, improvements in selection of candidate neural networks or candidate neural network architectures and their associated low rank adapters can be realized.

A plurality of candidate neural network models or subnets may be extracted from a supernet at 302, such as by random selection of trained subnets and their associated trained low rank adapters from a search space (such as the output trained subnets and low rank adapters at 312 of FIG. 3) or other such methods. The extracted candidate neural network subnets and associated low rank adapters in a further example may be selected to meet certain constraints, such as latency constraints, memory or processing power constraints, or other such constraints that may limit the size of the extracted subnets.

The extracted subnets and associated low rank adapters having the highest metrics or scores, such as the best accuracy in predicting the desired output of a set of test or training data, may be selected at 604 such that only a certain percentage of the best-performing models are retained for subsequent steps. At 606, the best-performing selected subnets and associated low rank adapters may be processed using a cross-over algorithm to create various new subnets, such as by swapping or combining elements from different subnets to create new subnets. Subnets may also be mutated randomly at 608, such as by randomly changing the topology, weights, and/or other elements of subnets to create new mutated subnets. In some examples, some subnets may be processed using cross-over to create new subnets, some subnets may be mutated to create new subnets, and some subnets may be processed using both cross-over and mutation in various orders. In various examples, subnets may be combined with associated low rank adapters before or during evolutionary search steps such as crossover and mutation, or such evolutionary steps may be applied to the subnets and/or the associated low rank adapters.

Subnets selected at 604 in some examples may be retained along with the genetically modified subnets. When subnets are again evaluated at 610 for performance metrics and filtered so that only the highest-performing percentage of subnets and their associated low rank adapters are retained, the genetically modified subnets may only be retained if they outperform other subnets such as the randomly sampled subnets. This process may mimic natural selection, in which genetic modifications are retained if they create a competitive advantage but are discarded if they result in a competitive disadvantage. Such advantageous genetic modifications to living organisms may occur and take hold over the course of many generations, and a decision may similarly be made at 612 as to whether more generations of genetic modification and filtering are desired for refining the sample or candidate neural network subnets. In some examples, the number of generations may be fixed, such as 50 or 100 generations, while in other examples new generations may be desired as long as improvement between generations continues to be observed such as by performing performance metric scoring as by evaluating whether a subnet and associated low rank adapter meet prediction accuracy or other such performance goals as part of the decision made at 612.

Once the desired number of generations of genetic modifications and filtering have taken place, the neural network subnet or genetically modified subnet and associated low rank adapter with the highest metric score is selected at 614. In some examples this may be a randomly selected subnet and associated low rank adapter extracted at 602, while in other examples this may be a subnet and associated low rank adapter that has been genetically modified such as with one or more generations of cross-over, mutation, or the like.

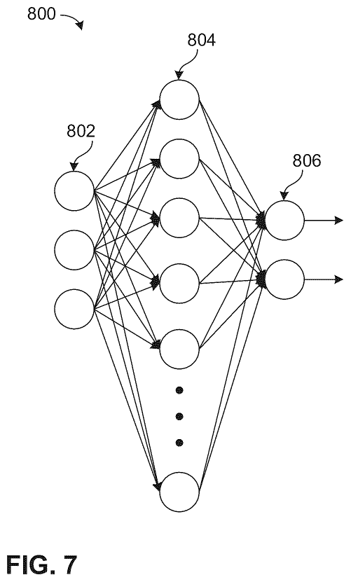

FIG. 7 is a schematic diagram of a neural network 700 formed in “layers” in which an initial layer is formed by nodes 702 and a final layer is formed by nodes 706. All or a portion of features of neural network 700 may be implemented various embodiments of systems described herein. Neural network 700 may include one or more intermediate layers, shown here by intermediate layer of nodes 704. Edges shown between nodes 702 and 704 illustrate signal flow from an initial layer to an intermediate layer. Likewise, edges shown between nodes 704 and 706 illustrate signal flow from an intermediate layer to a final layer. Although FIG. 7 shows each node in a layer connected with each node in a prior or subsequent layer to which the layer is connected, i.e., the nodes are fully connected, other neural networks will not be fully connected but will employ different node connection structures. While neural network 700 shows a single intermediate layer formed by nodes 804, other implementations of a neural network may include multiple intermediate layers formed between an initial layer and a final layer.

According to an embodiment, a node 702, 704 and/or 706 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

A neural network may be structured in layers, such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recurrent neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation. The neural networks employed in various examples can be any known or future neural network architecture, including traditional feed-forward neural networks, convolutional neural networks, or other such networks.

Some machine learning model training may include training a neural network, such as by applying backpropagation of output errors using training data to weights applied to activation functions linking nodes in a neural network. In some examples, a neural network may comprise a graph comprising nodes, such as may model neurons in a brain. In this context, a “neural network” means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

In one example embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In some implementations, transmission of an output signal from a node in a neural network may be inhibited if a strength of the output signal does not exceed a threshold value.

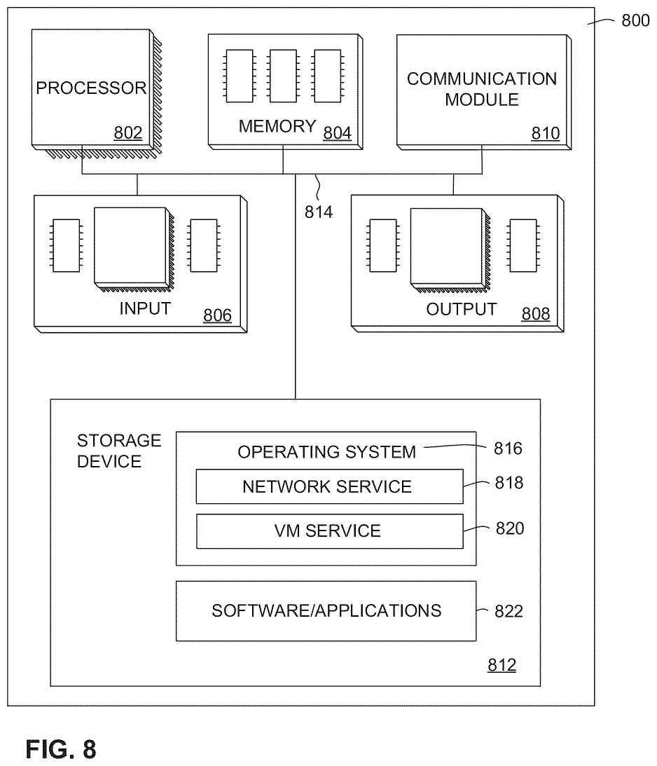

FIG. 8 is a block diagram of a general-purpose computerized system, consistent with an example embodiment. FIG. 8 illustrates only one particular example of computing device 1000, and other computing devices 800 may be used in other embodiments. Although computing device 800 is shown as a standalone computing device, computing device 800 may be any component or system that includes one or more processors or another suitable computing environment for executing software instructions in other examples, and need not include all of the elements shown here.

As shown in the specific example of FIG. 8, computing device 800 includes one or more processors 802, memory 804, one or more input devices 806, one or more output devices 808, one or more communication modules 810, and one or more storage devices 812. Computing device 800, in one example, further includes an operating system 816 executable by computing device 800. The operating system includes in various examples services such as a network service 818 and a virtual machine service 820 such as a virtual server. One or more applications such as software application 822 are also stored on storage device 812, and are executable by computing device 800.

Each of components 802, 804, 806, 808, 810, and 812 may be interconnected (physically, communicatively, and/or operatively) for inter-component communications, such as via one or more communications channels 814. In some examples, communication channels 814 include a system bus, network connection, inter-processor communication network, or any other channel for communicating data. Applications such as application 822 and operating system 816 may also communicate information with one another as well as with other components in computing device 1000.

Processors 802, in one example, are configured to implement functionality and/or process instructions for execution within computing device 800. For example, processors 802 may be capable of processing instructions stored in storage device 1012 or memory 1004. Examples of processors 802 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 812 may be configured to store information within computing device 800 during operation. Storage device 812, in some examples, is known as a computer-readable storage medium. In some examples, storage device 812 comprises temporary memory, meaning that a primary purpose of storage device 812 is not long-term storage. Storage device 812 in some examples is a volatile memory, meaning that storage device 812 does not maintain stored contents when computing device 800 is turned off. In other examples, data is loaded from storage device 812 into memory 804 during operation. Examples of volatile memories include random access memories (RAM), dynamic random access memories (DRAM), static random access memories (SRAM), and other forms of volatile memories known in the art. In some examples, storage device 812 is used to store program instructions for execution by processors 802. Storage device 812 and memory 804, in various examples, are used by software or applications running on computing device 800 such as application 822 to temporarily store information during program execution.

Storage device 812, in some examples, includes one or more computer-readable storage media that may be configured to store larger amounts of information than volatile memory. Storage device 812 may further be configured for long-term storage of information. In some examples, storage devices 812 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 800, in some examples, also includes one or more communication modules 810. Computing device 800 in one example uses communication module 810 to communicate with external devices via one or more networks, such as one or more wireless networks. Communication module 810 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 800 uses communication module 810 to wirelessly communicate with an external device such as via network 122 of FIG. 1.

Computing device 800 also includes in one example one or more input devices 806. Input device 806, in some examples, is configured to receive input from a user through tactile, audio, or video input. Examples of input device 806 include a touchscreen display, a mouse, a keyboard, a voice responsive system, video camera, microphone or any other type of device for detecting input from a user.

One or more output devices 808 may also be included in computing device 800. Output device 808, in some examples, is configured to provide output to a user using tactile, audio, or video stimuli. Output device 808, in one example, includes a display, a sound card, a video graphics adapter card, or any other type of device for converting a signal into an appropriate form understandable to humans or machines. Additional examples of output device 808 include a speaker, a light-emitting diode (LED) display, a liquid crystal display (LCD or OLED), or any other type of device that can generate output to a user.

Computing device 800 may include operating system 816. Operating system 816, in some examples, controls the operation of components of computing device 800, and provides an interface from various applications such as application 822 to components of computing device 800. For example, operating system 816, in one example, facilitates the communication of various applications such as federated learning module 822 with processors 802, communication unit 810, storage device 812, input device 806, and output device 808. Applications such as federated learning module 822 may include program instructions and/or data that are executable by computing device 800. These and other program instructions or modules may include instructions that cause computing device 800 to perform one or more of the other operations and actions described in the examples presented herein.

Features of example computing devices such as those shown in FIGS. 1 and 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1 and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Some embodiments may be described, at least in part, by the following numbered clauses or by any combination thereof:

Clause 1: A method of training a low rank adapter associated with a neural network subnet, comprising: generating a neural network supernet embedding one or more of a plurality of neural network subnets having different topologies; extracting a neural network subnet from the neural network supernet by extracting a fraction of nodes from the neural network supernet; training a low rank adapter associated with the extracted neural network subnet, the low rank adapter receiving at least a portion of low rank adapter inputs that are the same as extracted neural network subnet inputs and having at least a portion of outputs of the low rank adapter combined with outputs of the extracted neural network subnet; and providing the trained low rank adapter associated with the extracted neural network subnet as an output.

Clause 2: The method of clause 1, wherein the neural network supernet is pre-trained.

Clause 3: The method of clause 2, wherein training a low rank adapter comprises training the low rank adapter while leaving the extracted neural network subnet unmodified.

Clause 4: The method of any of clauses 2-3, further comprising initializing at least a layer of a decoder portion of the low rank adapter with zeros before training the low rank adapter.

Clause 5: The method of any of clauses 2-4, further comprising initializing at least a portion of an encoder portion of the low rank adapter with random weights before training the low rank adapter.

Clause 6: The method of any of the aforementioned clauses, wherein at least a portion of the extracted neural network subnet and at least a portion of the low rank adapter are initialized with random weights before training the low rank adapter.

Clause 7: The method of clause 6, further comprising training the extracted neural network subnet along with training the associated low rank adapter by updating the extracted fraction of nodes of the neural network supernet.

Clause 8: The method of any of the aforementioned clauses, wherein the low rank adapter comprises inputs and outputs corresponding to inputs and outputs of the extracted neural network subnet.

Clause 9: The method of any of the aforementioned clauses, wherein combining at least a portion of the outputs of the low rank adapter with the outputs of the extracted neural network subnet comprises adding at least a portion of the outputs of the low rank adapter with the outputs of the extracted neural network subnet.

Clause 10: The method of any of the aforementioned clauses, further comprising extracting a plurality of neural network subnets having different topologies from the neural network supernet, each of the plurality of extracted neural network subnets having a trained low rank adapter associated with the respective neural network subnets, and selecting a candidate neural network from among the plurality of neural network subnets having different topologies and its associated low rank adapter as a selected output neural network.

Clause 11: The method of clause 10, wherein selecting a candidate neural network from among the plurality of neural network subnets having different topologies and its associated low rank adapter as a selected output neural network comprises selecting a neural network subnet and associated low rank adapter meeting at least one topology constraint.

Clause 12: The method of any of clauses 10-11, further comprising comprises selecting a neural network subnet and associated low rank adapter for each layer of the neural network supernet.

Clause 13: The method of any of clauses 10-12, wherein selecting a candidate neural network from among the plurality of neural network subnets and their associated low rank adapters comprises using a genetic algorithm evolutionary search to select the neural network subnet and associated low rank adapter.

Clause 14: The method of clause 13, wherein the genetic algorithm evolutionary search comprises: selecting a plurality of neural network subnets having different topologies from the neural network supernet, including trained associated low rank adapters; filtering the selected neural network subnets and trained associated low rank adapters based, at least in part, on one or more performance metrics from among the selected plurality of neural network subnets and trained associated low rank adapters; applying one or more genetic modifications to the filtered neural network subnets and/or to their trained associated low rank adapters; and selecting at least one of the genetic-modified neural network subnets and associated low rank adapters based, at least in part, on the one or more performance metrics as the selected output neural network.

Clause 15: The method of clause 14, further comprising iterating the filtering of the selected neural network subnets based, at least in part, on the one or more performance metrics and applying one or more genetic modifications to the filtered neural network subnets repeatedly before selecting the genetic-modified candidate neural network based, at least in part, on the one or more performance metrics as the selected output neural network.

Clause 16: The method of any of clauses 14-15, wherein the one or more genetic modifications comprise at least one of cross-over between and/or among one or more neural network subnets and/or their associated low rank adapters and mutation of one or more neural network subnets and/or their associated low rank adapters.

Clause 17: A machine-readable medium with instructions encoded thereon, the instructions when executed operable to cause a computerized system to: generate a neural network supernet embedding one or more of a plurality of neural network subnets having different topologies; extract a candidate neural network subnet from the neural network supernet by extracting a fraction of nodes from the neural network supernet; train a low rank adapter associated with the extracted neural network subnet, the low rank adapter receiving at least a portion of low rank adapter inputs that are the same as extracted neural network subnet inputs and having at least a portion of outputs of the low rank adapter combined with outputs of the extracted neural network subnet; and provide the trained low rank adapter associated with the extracted neural network subnet as an output.

Clause 18: A method of selecting a neural network topology, comprising:
selecting a plurality of candidate neural networks having different topologies from among a plurality of neural network subnets embedded within a super-neural network, each of the plurality of neural network subnets having an associated trained low rank adapter; filtering the candidate neural networks and their associated low rank adapters based, at least in part, on meeting at least one architectural constraint for the candidate neural networks; and selecting a candidate neural network and associated low rank adapter based, at least in part, on the filtering to meet the at least one architectural constraint as a selected output neural network.

Clause 19: The method of selecting a neural network topology of clause 18, further comprising: filtering the selected candidate neural networks and their associated low rank adapters meeting the at least one architectural constraint based, at least in part, on one or more performance metrics from among the selected plurality of candidate neural networks and their associated low rank adapters; applying one or more genetic modifications to the filtered candidate neural networks and their associated low rank adapters; and selecting a genetic-modified candidate neural network and associated low rank adapter based, at least in part, on one or more performance metrics as the output neural network.

Clause 20: The method of selecting a neural network topology of any of clauses 18-19, further comprising merging the low rank adapter and associated candidate neural network selected as the output neural network into a combined output neural network.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A method of providing a neural network supernet by training low rank adapters associated with one or more subnets of the neural network supernet, comprising:
providing a neural network supernet embedding one or more of a plurality of neural network subnets having different topologies;
extracting a neural network subnet from the neural network supernet by extracting a portion of nodes from the neural network supernet;
training a low rank adapter associated with the extracted neural network subnet, the low rank adapter having at least a portion of low rank adapter input nodes that are coupled to receive a same input tensor as extracted neural network subnet input nodes and having a tensor output from at least a portion of output nodes of the low rank adapter combined with a tensor output from at least a portion of the output nodes of the extracted neural network subnet; and
providing the trained low rank adapter associated with the extracted neural network subnet as an output.

2. The method of claim 1, wherein the neural network supernet is pre-trained.

3. The method of claim 2, wherein training a low rank adapter comprises training the low rank adapter while leaving the extracted neural network subnet unmodified.

4. The method of claim 2, further comprising initializing at least a layer of a decoder portion of the low rank adapter with zeros before training the low rank adapter.

5. The method of claim 2, further comprising initializing at least a portion of an encoder portion of the low rank adapter with random weights before training the low rank adapter.

6. The method of claim 1, wherein at least a portion of the extracted neural network subnet and at least a portion of the low rank adapter are initialized with random weights before training the low rank adapter.

7. The method of claim 6, further comprising training the extracted neural network subnet along with training the associated low rank adapter by updating the extracted portion of nodes of the neural network supernet.

8. The method of claim 1, wherein the low rank adapter comprises inputs and outputs corresponding to inputs and outputs of the extracted neural network subnet.

9. The method of claim 1, further comprising combining at least a portion of the tensor output from the at least a portion of output node of the low rank adapter with tensor output from at least a portion of the output nodes of the extracted neural network subnet by adding at least a portion of the tensor output from the at least a portion of output node of the low rank adapter with the tensor output from at least a portion of the output nodes of the extracted neural network subnet.

10. The method of claim 1, further comprising extracting a plurality of neural network subnets having different topologies from the neural network supernet, each of the plurality of extracted neural network subnets having a trained low rank adapter associated with respective neural network subnets, and selecting a neural network from among the plurality of neural network subnets having different topologies and its associated low rank adapter as a selected output neural network.

11. The method of claim 10, wherein selecting a candidate neural network from among the plurality of neural network subnets having different topologies and its associated low rank adapter as a selected output neural network comprises selecting a neural network subnet and associated low rank adapter meeting at least one topology constraint.

12. The method of claim 10, further comprising comprises selecting a neural network subnet and associated low rank adapter for each layer of the neural network supernet.

13. The method of claim 10, wherein selecting a candidate neural network from among the plurality of neural network subnets and associated low rank adapters comprises selecting the neural network subnet and associated low rank adapter according to a genetic algorithm evolutionary search.

14. The method of claim 13, wherein the genetic algorithm evolutionary search comprises:
selecting a plurality of neural network subnets having different topologies from the neural network supernet, including trained associated low rank adapters;
filtering the selected plurality of neural network subnets and trained associated low rank adapters to provide filtered neural network subnets and associated low rank adapters based, at least in part, on one or more performance metrics from among the selected plurality of neural network subnets and trained associated low rank adapters;
applying one or more genetic modifications to the filtered neural network subnets and/or to trained low rank adapters associated with the filtered neural network subnets to provide one or more genetic-modified neural network subnets and/or associated low rank adapters; and
selecting at least one of the genetic-modified neural network subnets and associated low rank adapters based, at least in part, on the one or more performance metrics as the selected output neural network.

15. The method of claim 14, further comprising iterating the filtering the selected plurality of neural network subnets and associated low rank adapters based, at least in part, on the one or more performance metrics and applying one or more genetic modifications to the filtered neural network subnets and associated low rank adapters repeatedly before selecting the at least one of the genetic-modified candidate neural network subnets and/or associated low rank adapters based, at least in part, on the one or more performance metrics as the selected output neural network.

16. The method of claim 14, wherein the one or more genetic modifications comprise at least one of cross-over between and/or among one or more neural network subnets and/or their associated low rank adapters and mutation of one or more neural network subnets and/or their associated low rank adapters.

17. A machine-readable medium with instructions encoded thereon, the instructions when executed operable to cause a computerized system to:
provide a neural network supernet, the neural network supernet embedding one or more of a plurality of neural network subnets having different topologies;
extract a candidate neural network subnet from the neural network supernet by extracting a portion of nodes from the neural network supernet;
train a low rank adapter associated with the extracted neural network subnet, the low rank adapter having at least a portion of low rank adapter input nodes that are coupled to receive a same input tensor as extracted neural network subnet input nodes and having a tensor output from at least a portion of output nodes of the low rank adapter combined with a tensor output from at least a portion of the output nodes of the extracted neural network subnet; and
provide the trained low rank adapter associated with the extracted neural network subnet as an output.

18. A method of selecting a neural network topology, comprising:
selecting a plurality of candidate neural networks having different topologies from among a plurality of neural network subnets embedded within a super-neural network, each of the plurality of neural network subnets having an associated trained low rank adapter;
filtering the selected plurality of candidate neural networks and associated low rank adapters to meet at least one architectural constraint for the candidate neural networks; and
selecting a candidate neural network and associated low rank adapter based, at least in part, on the filtering to meet the at least one architectural constraint as a selected output neural network.

19. The method of selecting a neural network topology of claim 18, wherein:
filtering the selected plurality of candidate neural networks and their associated low rank adapters to meet the at least one architectural constraint comprises filtering the selected plurality of candidate neural networks and associated low rank adapters based, at least in part, on one or more performance metrics from among the selected plurality of candidate neural networks and their associated low rank adapters; and the method further comprises:
applying one or more genetic modifications to the filtered plurality of candidate neural networks and associated low rank adapters to provide a plurality of genetic-modified candidate neural networks and associated low rank adapters; and
selecting a genetic-modified candidate neural network and associated low rank adapter from among the plurality of genetic-modified candidate neural networks and associated low rank adapters based, at least in part, on one or more performance metrics as the output neural network.

20. The method of selecting a neural network topology of claim 18, further comprising merging the selected genetic-modified candidate neural network and associated low rank adapter into a combined output neural network.
